(19) United States
(12) Patent Application Publication
(10) Pub. No.: US 2013/0227213 A1
(43) Pub. Date: Aug. 29, 2013

(54) MEMORY CONTROLLER AND OPERATION METHOD THEREOF

(71) Applicant: SAMSUNG ELECTRONICS CO., LTD., (US)

(72) Inventors: Seong Hyeog CHOI, Hwaseong-si (KR); Jun Jin KONG, Yongin-si (KR); Jin Yeong KIM, Suwon-si (KR); Hong Rak SON, Anyang-si (KR); Yu Hun JEON, Seongnam-si (KR)

(73) Assignee: SAMSUNG ELECTRONICS CO., LTD., Suwon-si (KR)

(21) Appl. No.: 13/778,396

(22) Filed: Feb. 27, 2013

(30) Foreign Application Priority Data
Feb. 27, 2012 (KR) 10-2012-0019921

(51) Int. Cl. G06F 5/08

(52) U.S. Cl. CPC G06F 5/08
USPC 711/109

(57) ABSTRACT

A memory controller and an operation method thereof are provided. The operation method includes storing a plurality of random sequences, selecting at least one random sequence among the plurality of random sequences according to a data pattern of a data block, and performing conversion by at least one of randomizing the data block using the selected at least one random sequence and derandomizing the randomized data block using the selected at least one random sequence.

### CROSS-REFERENCE TO RELATED APPLICATIONS

This application claims priority under 35 U.S.C. § 119(a) from Korean Patent Application No. 10-2012-0019921 filed on Feb. 27, 2012, the disclosure of which is hereby incorporated by reference in its entirety.

### BACKGROUND

Apparatuses and method consistent with exemplary embodiment embodiments of the inventive concept relate to data processing technology, and more particularly, to a memory controller having a new structure for randomizing data according to a type of data and an operation method thereof.

A random sequence is used in communication systems or data storage systems. A randomizer converts data into randomized data using a random sequence. A derandomizer converts randomized data into derandomized data using a random sequence.

Some of data may fluidly change according to change in configuration such as firmware in a data storage system. At this time, a randomizer or a derandomizer may perform data conversion without consideration of the configuration. When the data conversion of the randomizer or the derandomizer is performed without consideration of the configuration, data reliability may be deteriorated.

### SUMMARY

According to an aspect of an exemplary embodiment, there is provided a memory controller including: a memory configured to store a plurality of random sequences; and a first converter configured to select at least one random sequence among the plurality of random sequences according to a data pattern of a data block and perform at least one of randomizing the data block using the selected at least one random sequence and derandomizing the randomized data block using the selected at least one random sequence. The data block may include first data having a first attribute.

The first converter may select the at least one random sequence by shifting the plurality of random sequences by a unit of a command received from a processing unit when the first converter receives the data block for performing the randomizing or receives the randomized data block for performing the derandomizing.

The first converter may perform the at least one of the randomizing the data block by performing a logical operation on the data block and the selected at least one random sequence and the derandomizing the randomized data block by performing the logical operation on the randomized data block and the selected at least one random sequence.

The memory controller may further include a first processing unit configured to execute a first command, received from a host, according to which the first converter selects the at least one random sequence and performs the randomizing or the derandomizing, and the memory may store the plurality of random sequences when the memory controller is booted or when the first processing unit executes the first command.

The memory controller may further include a second processing unit configured to execute a second command received from the host independently from the first command. At this time, the second processing unit may include another first converter to execute the second command.

The memory controller may further include a second converter, and the data block may include second data having a second attribute. The second converter may be configured to perform at least one of randomizing the second data using another at least one random sequence and derandomizing the randomized second data using the other at least one random sequence, while the first converter performs at least one of randomizing the first data using the at least one random sequence and derandomizing the randomized first data using the at least one random sequence.

The first data having the first attribute maybe metadata and the second data having the second attribute may be user data in the data block.

According to an aspect of another exemplary embodiment, there is provided an operation method of a memory controller. The operation method includes: storing a plurality of random sequences; selecting at least one random sequence among the plurality of random sequences according to a data pattern of a data block; and at least one of randomizing the data block using the selected at least one random sequence and derandomizing the randomized data block using the selected at least one random sequence. The data block may include first data having a first attribute.

The at least one random sequence may be selected by shifting the plurality of random sequences by a unit of a command received from a processing unit when receiving the data block for the randomizing or receiving the randomized data block for the derandomizing.

The performing the conversion may include randomizing the data block by performing an XOR operation on the data block and the selected at least one random sequence and transmitting the randomized data block to a memory device.

The performing the conversion may include receiving the randomized data block from a memory device, derandomizing the randomized data block by performing an XOR operation on the randomized data block and the selected at least one random sequence, and transmitting the derandomized data block to a host.

The data block may further include second data having a second attribute. The operation method may further include at least one of randomizing the second data using another at least one random sequence and derandomizing the randomized second data using the other at least one random sequence while performing at least one of randomizing the first data using the at least one random sequence and derandomizing the randomized first data using the at least one random sequence.

The storing the plurality of random sequences may include storing the plurality of random sequences when the memory controller is booted or when a processing unit executes a command according to which the selecting at least one random sequence is selected and one of the randomizing and the derandomizing is performed.

### BRIEF DESCRIPTION OF THE DRAWINGS

The above and other aspects of the inventive concept will become more apparent by describing in detail exemplary embodiments thereof with reference to the attached drawings, in which:

FIG. 1 is a block diagram of a memory system according to an exemplary embodiment;

FIG. 2 is a conceptual diagram of storage space within a memory device illustrated in FIG. 1, according to an exemplary embodiment;

FIG. 3A is a block diagram of a memory controller illustrated in FIG. 1, and FIG. 3B is a block diagram of a central processing unit (CPU) illustrated in FIG. 3A, according to an exemplary embodiment;

FIG. 4 is a conceptual diagram for explaining the operation of the memory controller illustrated in FIG. 1, according to an exemplary embodiment;

FIG. 5 is a conceptual diagram for explaining the operation of the memory controller illustrated in FIG. 1, according to an exemplary embodiment;

FIG. 6 is a diagram of random sequences stored in a memory illustrated in FIG. 3A, according to an exemplary embodiment;

FIG. 7 is a conceptual diagram for explaining the operation of the memory controller illustrated in FIG. 1 to select random sequences, according to an exemplary embodiment;

FIG. 8 is a block diagram of the operation of a memory system according to an exemplary embodiment;

FIG. 9 is a flowchart of an operation method of a memory controller according to an exemplary embodiment;

FIG. 10 is a flowchart of an operation method of a memory controller according to an exemplary embodiment; and

FIG. 11 is a schematic diagram of a multi-chip package including a plurality of semiconductor devices according to an exemplary embodiment.

### DETAILED DESCRIPTION OF THE EXEMPLARY EMBODIMENTS

The inventive concept now will be described more fully hereinafter with reference to the accompanying drawings, in which exemplary embodiments are shown. The inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

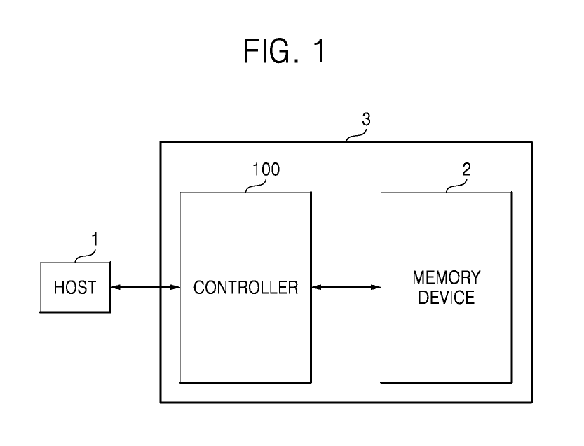

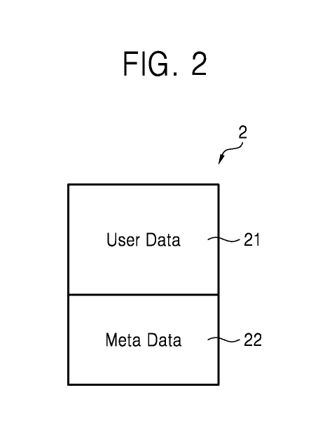

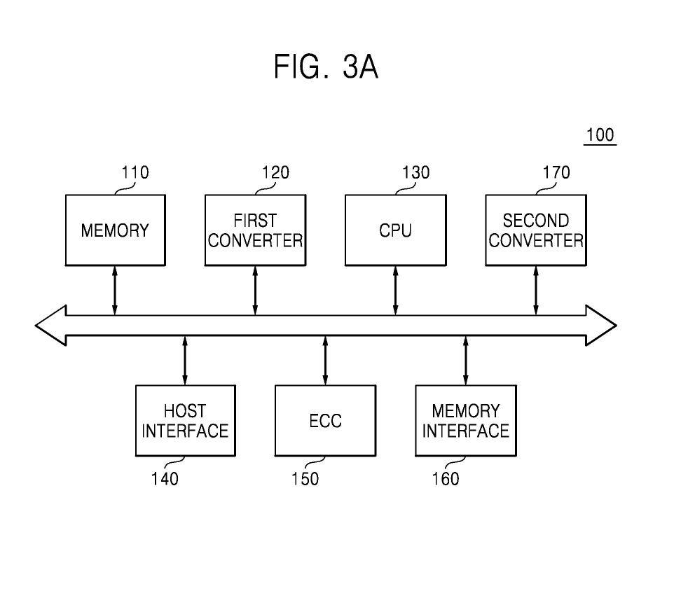

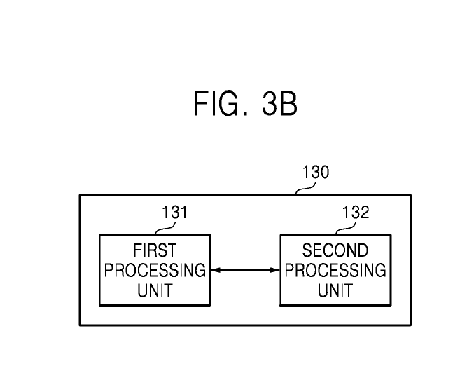

FIG. 1 is a block diagram of a memory system 3 according to an exemplary embodiment. FIG. 2 is a conceptual diagram of storage space within a memory device 2 illustrated in FIG. 1, according to an exemplary embodiment. FIG. 3A is a block diagram of a memory controller 100 illustrated in FIG. 1, according to an exemplary embodiment. Referring to FIG. 1, the memory system 3 is connected with a host 1 and includes the memory controller 100 and the memory device 2.

The memory system 3 refers to any memory system that includes at least one of a randomizer and a derandomizer and has been known up to now or is under development. Accordingly, the memory system 3 may be implemented as a personal computer (PC), a tablet PC, a notebook computer, a memory card, a smart card, a mobile telephone, a smart phone, a car navigator, a data server, a hard disk drive (HDD), a solid state drive (SDD), or a network-attached storage (NAS).

The host 1 sends a command to the memory system 3 so that the memory controller 100 executes the command. The command may refer to a read operation, an erase operation, or a program operation. The memory controller 100 may access the memory device 2 to read, erase, or program a data block in response to the command.

The memory device 2 may be implemented by a non-volatile memory device storing data. The non-volatile memory device may be electrically erasable programmable read-only memory (EEPROM), flash memory, magnetic random access memory (MRAM), spin-transfer torque MRAM, conductive bridging RAM (CBRAM), ferroelectric RAM (FeRAM), phase-change RAM (PRAM) also known as ovonic unified memory (OUM), resistive RAM (RRAM or ReRAM), nanotube RRAM, polymer RAM (PoRAM), nano floating gate memory (NFGM), holographic memory, molecular electronic memory device, or insulator resistance change memory. A memory cell of the non-volatile memory device may store one or more bits.

The memory controller 100 generates an address and a command according to an instruction of the host 1 to control the operation, for example, the program operation, the read operation, or the erase operation, of the memory device 2. The memory device 2 performs an operation according to the command and transmits a result of the operation to the memory controller 100. The memory device 2 is connected with the memory controller 100 via a bus through which commands, data, and status signals are transferred.

A data block transmitted between the memory controller 100 and the memory device 2 includes data having a first attribute and data having a second attribute. As shown in FIG. 2, the data having the first attribute and the data having the second attribute may be separately stored in the storage space of the memory device 2.

For instance, the data having the first attribute may be metadata. The metadata is managed by the memory controller 100 for the operation of the memory system 3 and may include a mapping table, data used for algorithms for the improvement of performance, a bad block management table, and other data necessary for system operation.

The data having the second attribute may be user data. The user data is target data of the program, erase or read operation when the host 1 requests to perform the operation. In other words, the data having the second attribute may be user data received from the host 1 and the data having the first attribute may be metadata generated by the memory controller 100 based on the second attribute. The memory controller 100 and the memory device 2 may be packaged in a single chip or separate chips.

Referring to FIG. 3A, the memory controller 100 includes a memory 110, a first converter 120, a central processing unit (CPU) 130, a host interface 140, an error correction code (ECC) block 150, and a memory interface 160.

The memory 110 may be used as an operation memory of the CPU 130. The memory 110 may include existing volatile memory cells such as dynamic random access memory (DRAM) cells, static RAM (SRAM) cells, thyristor RAM (T-RAM) cells, zero capacitor RAM (Z-RAM) cells, or twin transistor RAM (TTRAM) cells, or volatile memory cells under development. Alternatively, the memory 110 may be implemented by read only memory (ROM).

The memory 110 may store a plurality of predetermined random sequences. The random sequences may be loaded to the memory 110 when the memory controller 100 is booted or when the CPU 130 executes a command at the request of the host 1.

The random sequences may be combined into operation blocks, which are shifted in units when the CPU 130 executes a command, for the efficient use of the memory 110. For instance, when the CPU 130 is a 32-bit CPU and a unit memory cell of the memory device 2 is a two-bit multi-level cell (MLC), since the two-bit MLC has 128 pages, a memory capacity of 512 Mbytes (=32 bits×128 pages) is used.

When the host 1 requests to perform the program operation on the memory device 2, the first converter 120 changes data to be programmed, which is received from the host 1, to be suitable to the memory device 2. For instance, the first converter 120 may select some of the random sequences according to data pattern of a data block and randomize the data block using the selected random sequences.

When the host 1 requests to perform the read operation on the memory device 2, the first converter 120 changes data read from the memory device 2 to be suitable to the host 1. For instance, the first converter 120 may select some of the random sequences according to data pattern of a randomized data block and derandomize the randomized data block using the selected random sequences.

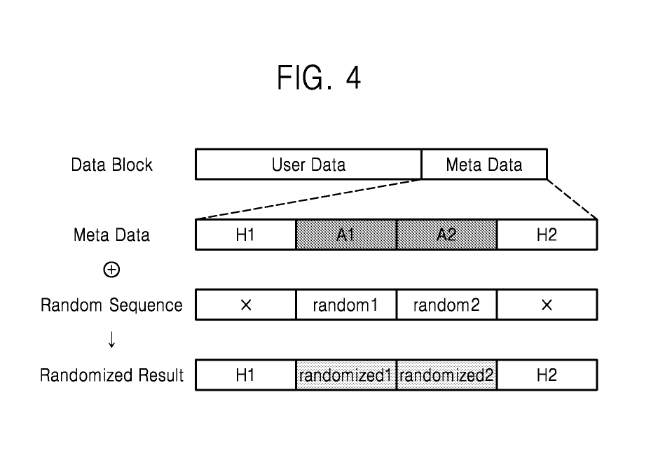

When the first converter 120 randomizes or derandomizes a data block using the selected random sequences, the random sequences may be shifted and loaded in units of execution of a command of the CPU 130, which will be described in detail with reference to FIGS. 4 through 8 later.

The first converter 120 can be embodied as program instructions that can be executed using various types of computers and recorded in a computer readable medium. The computer readable medium may include a program instruction, a data file, or a data structure individually or a combination thereof. The program instruction recorded in the medium may be specially designed and configured for implementing the present embodiment or may have already been known to and available to those of skill in the art of computer software. Examples of the computer readable medium include magnetic media such as hard disks, floppy disks and magnetic tapes; optical media such as CD-ROMs and DVDs; magneto-optical media such as floptical disks; and hardware devices such as ROM devices, RAM devices and flash memory devices that are specially configured to store and execute program instructions. Examples of the program instruction include machine codes created by a compiler and high-level language codes that can be executed in a computer using an interpreter. The hardware devices may be embodied as at least one software module configured to perform operations according to some embodiments of the present invention and vice versa is possible.

Although the first converter 120 is illustrated as a separate element, the inventive concept is not restricted thereto. The first converter 120 may be implemented within the CPU 130.

The CPU 130 may control data transmission among the memory 110, the host interface 140, the ECC block 150, and the memory interface 160 via a bus. The CPU 130 may be implemented as a multi-core processor comprising at least two processing units. According to an exemplary embodiment, the CPU 130 may include first and second processing units illustrated in FIG. 3B. The first processing unit(131) may execute a first command received from the host 1 and the second processing unit(132) may execute a second command received from the host 1 independently from the operation of the first processing unit. For performing randomization and/or derandomization according to the second command independently from the first command, the memory controller 100 illustrated in FIG. 3A may include another first converter and another second converter corresponding to the first converter 120 and the second converter 170, respectively.

The host interface 140 may interface data between the host 1 and the memory controller 100 according to the protocol of the host 1 connected to the memory system 3. The ECC block 150 may detect and correct errors in data read from the memory device 2.

The memory interface 160 may interface data between the memory device 2 and the memory controller 100. The memory system 3 may be implemented as a universal serial bus (USB) flash drive or a memory stick.

The memory controller 100 may also include a second converter 170. The second converter 170 may randomize second attribute data (e.g., user data) of first data from the memory 110 into second attribute data of second data. In addition, the second converter 170 may derandomize second attribute data of third data resulting from the randomization into second attribute data of fourth data. At this time, the randomization or derandomization of the second attribute data may be performed using a random sequence generated by a circuit (e.g., a pseudorandom number generator) generating random sequences.

Although the second converter 170 is embodied inside the memory controller 100, the inventive concept is not restricted thereto. The second converter 170 may be implemented between the memory controller 100 and a card interface of the memory device 2.

The first converter 120 and the second converter 170 may be positioned before or after the ECC block 150 to randomize or derandomize data.

FIG. 4 is a conceptual diagram for explaining the operation of the memory controller 100 illustrated in FIG. 1 according to an exemplary embodiment. FIG. 4 shows the operation of the memory controller 100 when the host 1 requests the memory system 3 to program a data block.

It is assumed that the data block has the first attribute and includes a data pattern of (H1, A1, A2, H2), and data to be randomized are Al and A2. The data block may include data (metadata) having the first attribute and data (user data) having the second attribute as well. For convenience' sake in the description, the conversion of the first attribute (metadata) in the data block is illustrated.

Upon receiving the data block from the host 1, the first converter 120 downloads random sequences from the memory 110 based on the data attributes of the data block. The data attributes indicate the first or second attribute and whether data is to be randomized or not. Accordingly, random sequences are selected according to the data pattern. In detail, random sequences x, random1, random2 and x are selected according to the attributes of the data pattern (H1, A1, A2, H2), which indicate whether the data H1, A1, A2, and H2 will be randomized or not. In the embodiment illustrated in FIG. 4, random sequences setting the data A1 and A2 to be randomized and the data H1 and H2 not to be randomized are loaded to the first converter 120.

The first converter 120 randomizes the data block having the first attribute using the selected random sequences. The randomization may be a logic operation including an XOR operation.

Accordingly, an XOR operation is performed on the data block (H1, A1, A2, H2) having the first attribute and the random sequences x, random1, random2 and x, so that the data block (H1, A1, A2, H2) is randomized into “H1, randomized1, randomized2, H2”.

In reverse, when the host 1 requests the memory system 3 to read the data block which is randomized as above, the operation of the memory controller 100 is derandomization using the random sequences used during the randomization.

In detail, when the memory controller 100 receive a data block that has been randomized from the memory device 2, the randomized data block having the first attribute has the data pattern of (H1, randomized1, randomized2, H2).

The first converter 120 selects random sequences from the memory 110 based on the data pattern (H1, randomized1, randomized2, H2). The selected random sequences are the same as the random sequences x, random1, random2, and x used during the randomization.

The first converter 120 derandomizes by performing an XOR operation on the randomized data block having the first attribute and the selected random sequences x, random1, random2, and x. In other words, randomization is performed by performing one XOR operation on data and random sequences and derandomization is performed by performing two XOR operations on the data and the random sequences.

As a result of the derandomization, H1, A1, A2, and H2 are output to the host 1.

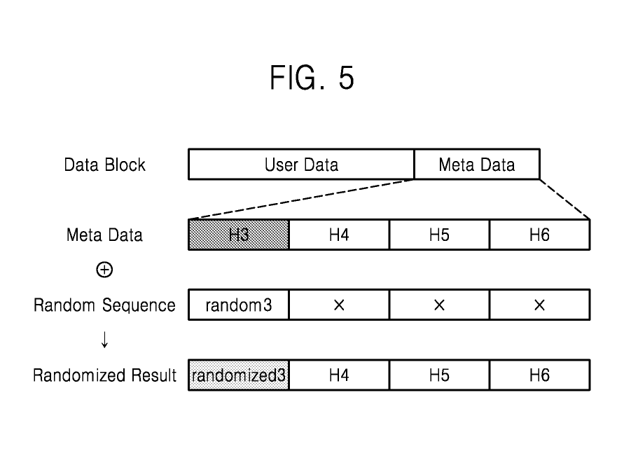

FIG. 5 is a conceptual diagram for explaining the operation of the memory controller 100 illustrated in FIG. 1 according to another exemplary embodiment. When the host 1 requests the memory system 3 to program a data block, it is assumed that the data block has the first attribute and includes a data pattern of (H3, H4, H5, H6) and data to be randomized is H3.

Upon receiving the data block from the host 1, the first converter 120 selects random sequences from the memory 110 based on the data pattern of the data block. Accordingly, the random sequences are selected according to the data pattern of (H3, H4, H5, H6). In other words, random sequences random3, x, x, and x setting the data H3 to be randomized and the data H4, H5, and H6 not to be randomized are selected. The first converter 120 randomizes the data block (H3, H4, H5, H6) having the first attribute by performing an XOR operation on the data block (H3, H4, H5, H6) and the random sequences random3, x, x, and x selected according to the data pattern of the data block.

In reverse, when the host 1 requests the memory system 3 to read the randomized data, the memory controller 100 derandomizes by performing an XOR operation on the randomized data block having the first attribute, received from the memory device 2, and the random sequences random3, x, x, and x selected according to the data pattern of the data block. As a result, the randomized data (randomized3, H4, H5, H6) is randomized into the data block (H3, H4, H5, H6).

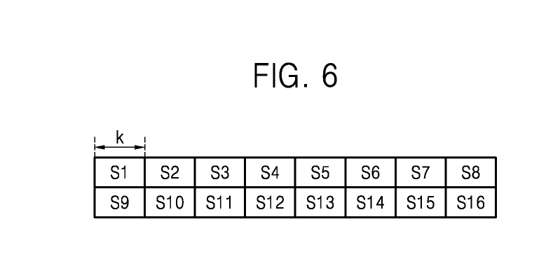

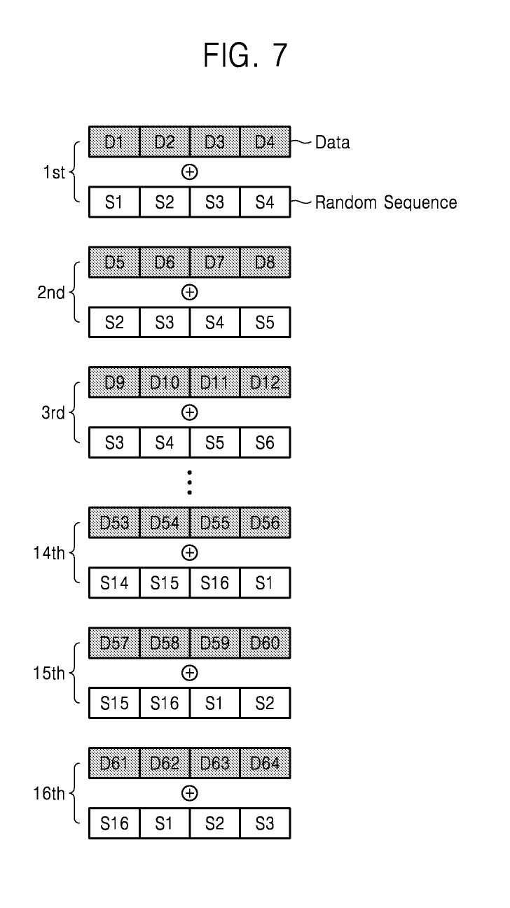

FIG. 6 is a diagram of random sequences loaded in the memory 110 illustrated in FIG. 3A, according to an exemplary embodiment. FIG. 7 is a conceptual diagram for explaining the operation of the memory controller 100 illustrated in FIG. 1 to select random sequences.

The memory 110 may store a plurality of random sequences S1 through S16 as shown in FIG. 6. FIG. 6 shows the random sequences S1 through S16 when the CPU 130 is a 32-bit CPU.

Each of the random sequences S1 through S16 has four bytes, i.e., 32 bits, which is a command execution unit “k” of the CPU 130. The first converter 120 may use random sequences by shifting by the command execution unit “k” of the CPU 130 when randomizing or derandomizing metadata. Accordingly, the capacity of the memory 110 storing the random sequences S1 through S16 can be efficiently used.

In detail, referring to FIG. 7, when the first converter 120 receives meta data D1, D2, D3 and D4, it downloads the random sequences S1, S2, S3 and S4 corresponding to the data pattern of the meta data D1, D2, D3 and D4 from the memory 110. The first converter 120 randomizes the metadata D1, D2, D3 and D4 by performing an XOR operation on the meta data D1, D2, D3 and D4 and the random sequences S1, S2, S3 and S4. At this time, the random sequences S1, S2, S3 and S4 may be sequences that determine whether to randomize data or not, as illustrated in FIG. 4 or 5.

Thereafter, when the first converter 120 receives meta data D5, D6, D7 and D8, it downloads the random sequences S2, S3, S4 and S5 corresponding to the data pattern of the meta data D5, D6, D7 and D8 from the memory 110. The first converter 120 randomizes the meta data D5, D6, D7 and D8 by performing an XOR operation on the meta data D5, D6, D7 and D8 and the random sequences S2, S3, S4 and S5.

In other words, each time when consecutive metadata is randomized or derandomized, random sequences resulting from shift by the command execution unit “k” of the CPU 130 are used. As described above, when the random sequences S1, S2, S3 and S4 are used in the first randomization, the random sequences S2, S3, S4, and S5 obtained after the shift are used in the second randomization.

Consequently, when data D1 through D64 is randomized by the memory controller 100, random sequences are shifted beginning with S1 and each random sequence is used four times. Accordingly, the capacity for storing random sequences in the memory 110 is reduced. In addition, since random sequences are used according to a data pattern when an XOR operation is performed, the efficiency of randomization and derandomization is increased.

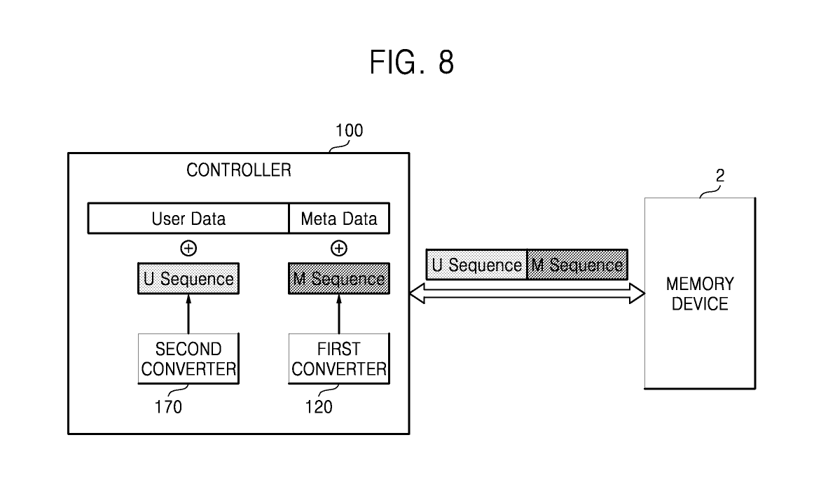

FIG. 8 is a block diagram of the operation of a memory system according to an exemplary embodiment. Referring to FIG. 8, when the memory controller 100 communicates data with the memory device 2, it may randomize or derandomize metadata with a first random sequence “M Sequence” loaded from the memory 110 using the first converter 120. Meanwhile, the memory controller 100 may randomize or derandomize user data with a second random sequence “U Sequence” using the second converter 170. The second converter 170 may be implemented by a conversion circuit such as a randomizer or derandomizer.

Consequently, the metadata is randomized or derandomized separately from the user data, and therefore, the meta data is randomized or derandomized according to a data pattern corresponding to the change in configuration of the memory controller 100. As a result, data reliability is increased.

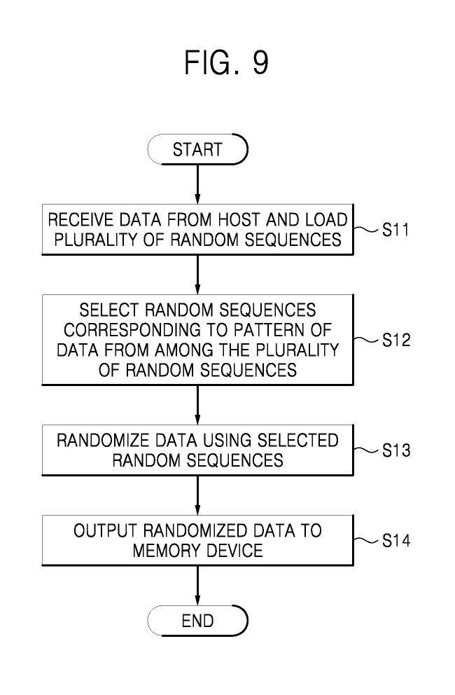

FIG. 9 is a flowchart of an operation method of the memory controller 100 according to an exemplary embodiment. Referring to FIG. 9, in order to randomize a data block having a first attribute, the memory controller 100 loads a plurality of random sequences in operation S11. The random sequences may be loaded when the memory controller 100 is booted or is requested to perform an operation from the host 1. The data block having the first attribute may be metadata.

The memory controller 100 selects random sequences corresponding to the data pattern of the data block from among the loaded random sequences in operation S12 and randomizes the data block using the selected random sequences in operation S13.

The memory controller 100 outputs the randomized data block to the memory device 2 in operation S14.

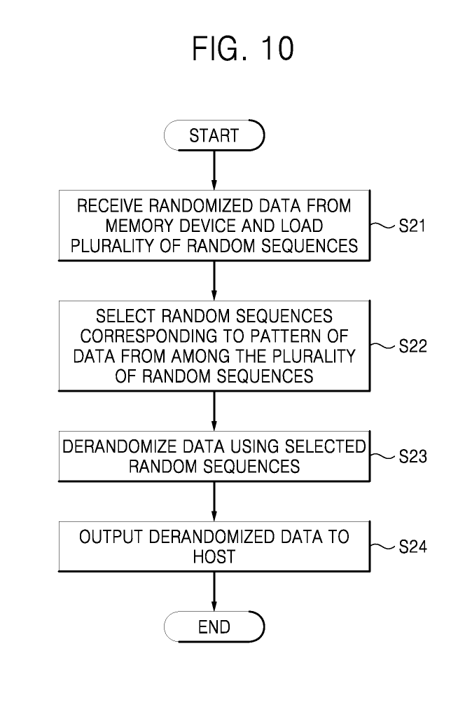

FIG. 10 is a flowchart of an operation method of the memory controller 100 according to an exemplary embodiment. Referring to FIG. 10, in order to derandomize a data block having a first attribute, the memory controller 100 loads a plurality of random sequences in operation S21. The random sequences may be loaded when the memory controller 100 is booted or is requested to perform an operation from the host 1. At this time, the data block may be metadata.

The memory controller 100 selects random sequences corresponding to the data pattern of the data block from among the loaded random sequences in operation S22 and derandomizes the data block using the selected random sequences in operation S23.

The memory controller 100 outputs the derandomized data block to the host 1 in operation S24.

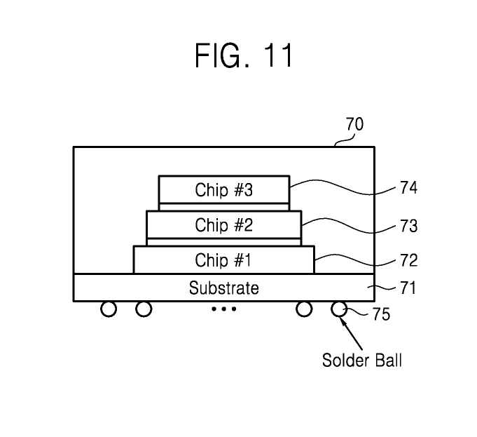

FIG. 11 is a schematic diagram of a multi-chip package 70 including a plurality of semiconductor devices 72, 73, and 74 according to some embodiments of the inventive concept. Referring to FIG. 11, the multi-chip package 70 may include a plurality of the semiconductor devices, i.e., first through third chips 72, 73, and 74 which are sequentially stacked on a package substrate 71. Each of the semiconductor devices 72 through 74 may be the CPU 130, the memory controller 100 or the memory device 2 that has been described above. The memory device 2 may be a volatile or non-volatile memory device. The memory controller 100 according to the above embodiments may be included within at least one of the semiconductor devices 72 through 74 or may be implemented on the package substrate 71. A through-silicon via (TSV) (not shown), a bonding wire (not shown), a bump (not shown), or a solder ball 75 may be used to electrically connect the semiconductor devices 72 through 74 with one other.

As described above, according to the above embodiments, randomization and/or derandomization are performed according to the data pattern so that data reliability is increased.

While the inventive concept has been particularly shown and described with reference to exemplary embodiments thereof, it will be understood by those of ordinary skill in the art that various changes in forms and details may be made therein without departing from the spirit and scope of the inventive concept as defined by the following claims.

What is claimed is:

1. A memory controller comprising:
a memory configured to store a plurality of random sequences; and
a first converter configured to select at least one random sequence among the plurality of random sequences according to a data pattern of a data block and perform at least one of randomizing the data block using the selected at least one random sequence and derandomizing the randomized data block using the selected at least one random sequence.

2. The memory controller of claim 1, wherein the first converter selects the at least one random sequence by shifting the plurality of random sequences by a unit of a command received from a processing unit when the first converter receives the data block for performing the randomizing or receives the randomized data block for performing the derandomizing.

3. The memory controller of claim 1, wherein the first converter performs the at least one of the randomizing the data block by performing a logical operation on the data block and the selected at least one random sequence and the derandomizing the randomized data block by performing the logical operation on the randomized data block and the selected at least one random sequence.

4. The memory controller of claim 3, wherein the logical operation comprises an XOR operation, and
wherein the derandomizing the randomized data block comprises performing the logical operation twice.

5. The memory controller of claim 1, further comprising a first processing unit configured to execute a first command, received from a host, according to which the first converter selects the at least one random sequence and performs the randomizing or the derandomizing,
wherein the memory stores the plurality of random sequences when the memory controller is booted or when the first processing unit executes the first command.

6. The memory controller of claim 1, further comprising a second processing unit configured to execute a second command received from the host independently from the first command, and
wherein the second processing unit comprises another first converter to select another at least one random sequence among the plurality of random sequences according to a data pattern of another data block and perform at least one of randomizing the other data block using the selected other at least one random sequence and derandomizing the randomized data block using the selected other at least one random sequence.

7. The memory controller of claim 1, further comprising a second converter,
wherein the data block comprises first data having a first attribute and second data having a second attribute,
wherein the second converter is configured to perform at least one of randomizing the second data using another at least one random sequence and derandomizing the randomized second data using the other at least one random sequence, while the first converter performs at least one of randomizing the first data using the at least one random sequence and derandomizing the randomized first data using the at least one random sequence.

8. The memory controller of claim 7, wherein the first data having the first attribute is metadata and the second data having the second attribute is user data in the data block.

9. A memory system comprising:
a host configured to output a command;
a memory device configured to store the data block; and
the memory controller of claim 1,
wherein the memory controller performs at least one of:
storing the randomized data block in the memory device according to the command; and
derandomizing the randomized data block stored in the memory device and outputting the derandomized data block to the host according to another command from the host.

10. A memory controller comprising:
a memory configured to store a plurality of random sequences; and
a converter which selects at least one random sequence among the plurality of random sequences according to a data pattern of a data block received from a host, and randomizes the data block according to the selected at least one random sequence,
wherein the data pattern is determined based on a portion of the data block which is a target of randomization.

11. The memory controller of claim 10, wherein the converter selects another at least one random sequence among the plurality of random sequences according to a data pattern of a data block received from a memory device, and derandomizes the data block according to the selected other at least one random sequence,
wherein the data pattern is determined based on a portion of the data block which is a target of derandomization.

12. An operation method of a memory controller, the operation method comprising:
storing a plurality of random sequences;
selecting at least one random sequence among the plurality of random sequences according to a data pattern of a data block; and
performing conversion by at least one of randomizing the data block using the selected at least one random sequence and derandomizing the randomized data block using the selected at least one random sequence.

13. The operation method of claim 12, wherein the at least one random sequence is selected by shifting the plurality of random sequences by a unit of a command received from a processing unit when receiving the data block for the randomizing or receiving the randomized data block for the derandomizing.

14. The operation method of claim 12, wherein the performing the conversion comprises:
randomizing the data block by performing a logical operation on the data block and the selected at least one random sequence; and
transmitting the randomized data block to a memory device.

15. The operation method of claim 14, wherein the logical operation comprises an XOR operation.

16. The operation method of claim 12, wherein the performing the conversion comprises:
receiving the randomized data block from a memory device;
derandomizing the randomized data block by performing a logical operation on the randomized data block and the selected at least one random sequence; and
transmitting the derandomized data block to a host.

17. The operation method of claim 16, wherein the logical operation comprises an XOR operation, and
wherein the derandomizing the randomized data block is performed by performing the logical operation twice.

18. The operation method of claim 12, wherein the data block further comprises first data having a first attribute and second data having a second attribute,
wherein the operation method further comprises at least one of randomizing the second data using another at least one random sequence and derandomizing the randomized second data using the other at least one random sequence while performing at least one of randomizing the first data using the at least one random sequence and derandomizing the randomized first data using the at least one random sequence,.

19. The operation method of claim 12, wherein the storing the plurality of random sequences comprises storing the plurality of random sequences when the memory controller is booted or when a processing unit executes a command according to which the selecting at least one random sequence is selected and one of the randomizing and the derandomizing is performed.

20. A recording medium for storing the operation method of claim 12 as a computer readable code and executing the computer readable code.
